(19) United States
(12) Patent Application Publication
(10) Pub. No.: US 2018/0285894 A1
(43) Pub. Date: Oct. 4, 2018

(54) METHOD AND A SYSTEM FOR CONDITION BASED REAL TIME MARKETING OF PERISHABLE COMMODITIES

(71) Applicant: Foller Oy, Espoo (FI)

(72) Inventors: Tomi KANKAINEN, Espoo (FI); Jaakko ANTTILA, Espoo (FI); Vladimir ABRAMOV, Espoo (FI); Antti ELOHEIMO, Espoo (FI); Ville HIRVONEN, Espoo (FI); Anu KANKAINEN, Espoo (FI)

(73) Assignee: Foller Oy, Espoo (FI)

(21) Appl. No.: 15/761,920

(22) PCT Filed: Sep. 20, 2016
(86) PCT No.: PCT/FI2016/050647

§ 371 Date: Mar. 21, 2018

Related U.S. Application Data
(60) Provisional application No. 62/221,369, filed on Sep. 21, 2015.

(51) Int. Cl. G06Q 30/02

(52) U.S. Cl. CPC G06Q 30/0201; G06Q 30/0283

(57) ABSTRACT

A system for real time marketing of perishable commodities, for example food, is presented. The system comprises quality sensors (103) for obtaining information related to quality of the perishable commodities, a sale monitoring system (104) for producing sale monitoring data indicative of consumer demand of the perishable commodities, and a processing and data transfer system (105) for producing quality indicator data on the basis of the information obtained with the quality sensors. The processing and data transfer system is configured to determine selling prices of the perishable commodities in accordance with at least the quality indicator data and the sale monitoring data so that a weakening in the quality tends to decrease a selling price whereas an increase in the consumer demand tends to increase the selling price. Thus, the portion of the perishable commodities which remain unsold can be reduced without excessively sacrificing the price level.

### FIELD OF THE DISCLOSURE

The disclosure relates to a method and a system for marketing food and/or other perishable commodities. More particularly, the disclosure relates to a method and a system for monitoring the quality of food and/or other perishable commodities and for marketing the food and/or other perishable commodities based on at least the monitored quality. Furthermore, the disclosure relates to a computer program for marketing food and/or other perishable commodities.

### BACKGROUND

An inherent challenge related to production, processing, retailing, and consumption of food and/or other perishable commodities is that a given lot of food or other perishable commodity loses its market value if the lot of food or other perishable commodity gets too old and/or is otherwise disqualified. For example food waste, or food loss, means that a portion of food is discarded or lost uneaten. There are numerous causes of the food waste, and the food waste may occur at the stages of production, processing, retailing, and consumption. It has been estimated that as much as about a half of all food would be wasted worldwide. In low-income countries, most of the food waste occurs during production, while in developed countries much food is wasted at retailing and consumption stages. As evident, the food waste causes significant economic losses to retailers such as grocers as well as to consumers.

A traditional method that is used by grocers to reduce the food waste is to reduce the selling price when the sell-by date of a given food lot in stock is approaching. The aim is to intensify the sales and thereby to avoid a situation where food whose sell-by date has been passed has to be wasted. This approach is, however, not free from challenges. One of the challenges is that the sell-by date does not reliably indicate the quality of the food but the sell-by date is only a rough estimate of a latest date at which the food is still good enough. Another one of the challenges is that the price reduction is noticed only by a limited group of consumers. Furthermore, in some cases, it might be challenging to set the price reduction so that the food lot whose sell-by date is approaching will be sold and thereby wasting is avoided but, on the other hand, economic losses due to a too big price reduction can be avoided.

Therefore, there is still a need for methods and systems for streamlining and improving the distribution chain of food and/or other perishable commodities in order to reduce the waste of food and/or other perishable commodities.

### SUMMARY

The following presents a simplified summary in order to provide a basic under-standing of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new system for marketing food and/or other perishable commodities. A system according to the invention comprises:
one or more quality sensors for obtaining information related to the quality of the food and/or other perishable commodities,
a sale monitoring system for producing sale monitoring data indicative of the consumer demand of the food and/or other perishable commodities on the basis of the temporal trend of the sale of the food and/or other perishable commodities, and
a processing and data transfer system for producing quality indicator data on the basis of the information obtained with the one or more quality sensors.

The processing and data transfer system is configured to determine one or more selling prices of the food and/or other perishable commodities in accordance with at least the quality indicator data and the sale monitoring data. In addition to the quality indicator data and the sale monitoring data, it is possible to use also other data for determining the selling prices. The other data may express for example the current weather, a weather forecast, the current time of day, the current day of week, the current month, and/or other data indicative of one or more factors which may have an influence on the buying behavior of consumers.

The selling prices are determined so that a weakening in the quality of a portion of the food and/or other perishable commodities tends to decrease the selling price of this portion of the food and/or other perishable commodities and an increase in the consumer demand of the portion of the food and/or other perishable commodities tends to increase the selling price of the portion of the food and/or other perishable commodities. Therefore, the sales prices are adaptively controlled in accordance with the consumer demand when the expiry of the usefulness of the food and/or other perishable commodities is approaching. Thus, there is no need to set a fixed price reduction so that one has to balance between a risk of a situation where a significant portion of the food and/or other perishable commodities will not be sold and a risk of economic losses due to a too big price reduction. Thus, the portion of the food and/or other perishable commodities which may remain unsold can be reduced without excessively sacrificing the price level.

In accordance with the invention, there is provided also a new method for marketing food and/or other perishable commodities. A method according to the invention comprises:
obtaining, with one or more quality sensors, information related to the quality of the food and/or other perishable commodities,
producing sale monitoring data indicative of the consumer demand of the food and/or other perishable commodities on the basis of the temporal trend of the sale of the food and/or other perishable commodities,
producing quality indicator data on the basis of the information obtained with the one or more quality sensors, and
determining one or more selling prices of the food and/or other perishable commodities in accordance with at least the quality indicator data and the sale monitoring data.

In accordance with the invention, there is provided also a new computer program for marketing food and/or other perishable commodities. A computer program according to the invention comprises computer executable instructions for controlling a programmable processing system to:
produce sale monitoring data indicative of the consumer demand of the food and/or other perishable commodities on the basis of the temporal trend of the sale of the food and/or other perishable commodities,
produce quality indicator data indicative of the quality of the food and/or other perishable commodities on the basis of information obtained with one or more quality sensors and related to the quality of the food and/or other perishable commodities, and
determine one or more selling prices of the food and/or other perishable commodities in accordance with at least the quality indicator data and the sale monitoring data.

In accordance with the invention, there is provided also a new computer program product. The computer program product comprises a non-volatile computer readable medium, e.g. a compact disc “CD”, encoded with a computer program according to the invention.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

Exemplifying and non-limiting embodiments of the invention and their advantages are explained in greater detail below in the sense of examples and with reference to the accompanying drawings, in which:

FIG. 1 illustrates a system according to an exemplifying and non-limiting embodiment of the invention for real time marketing of food and/or other perishable commodities,

FIGS. 2a, 2b, and 2c illustrate operation of a system according to an exemplifying and non-limiting embodiment of the invention for real time marketing of food and/or other perishable commodities, and

FIG. 3 shows a flowchart of a method according to an exemplifying and non-limiting embodiment of the invention for real time marketing of food and/or other perishable commodities.

### DESCRIPTION OF EXEMPLIFYING AND NON-LIMITING EMBODIMENTS

The specific examples provided in the description below should not be construed as limiting the scope and/or the applicability of the accompanied claims. Lists and groups of examples provided in the description are not exhaustive unless otherwise explicitly stated.

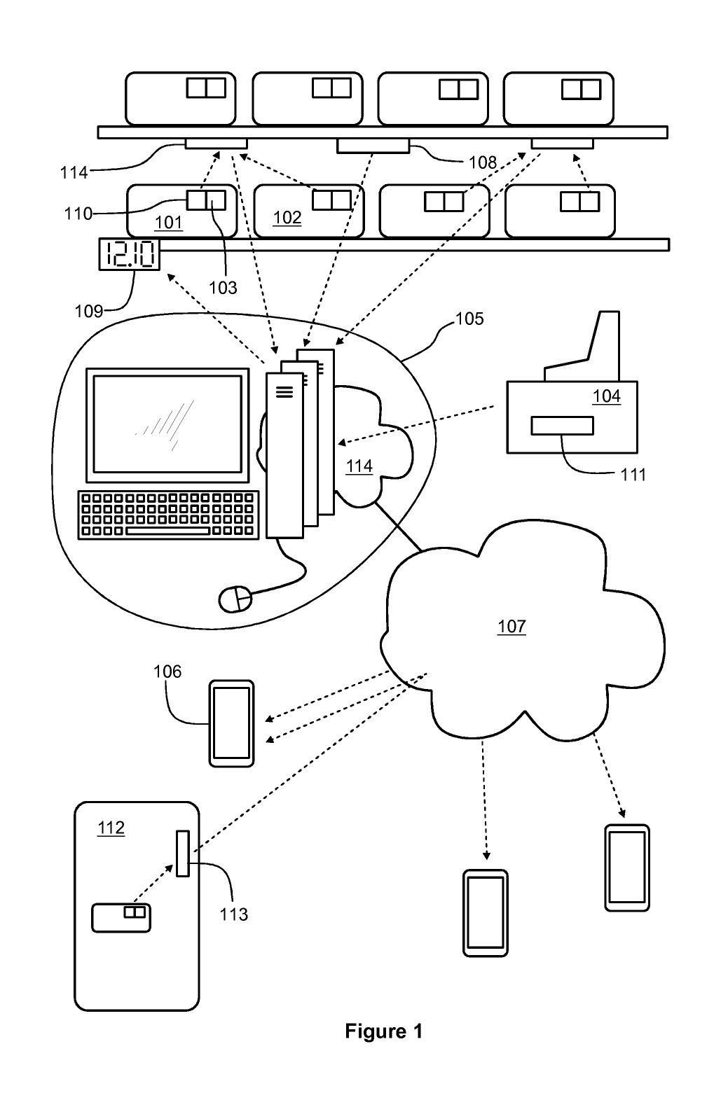

FIG. 1 illustrates a system according to an exemplifying and non-limiting embodiment of the invention for real time marketing of perishable commodities such as e.g. food, cosmetics, medicines, or other commodities which lose their quality and/or market value due to ageing and/or ambient conditions. The system comprises one or more quality sensors for obtaining information related to the quality of the perishable commodities. In the exemplifying case illustrated in FIG. 1, the perishable commodities are stored on shelves and each of the perishable commodities is provided with a quality sensor. The perishable commodities can be, for example but not necessarily, food packages. In FIG. 1, two of the perishable commodities are denoted with references 101 and 102 and the quality sensor which is attached to the perishable commodity 101 is denoted with a reference 103. A quality sensor may comprise for example a gas sensor for detecting one or more gases in the vicinity of the perishable commodities. The gas to be detected can be for example ethanol vapor which is emitted by certain types of food when the food is losing its quality due to ageing and/or ambient conditions. For another example, a quality sensor may comprise a temperature sensor for detecting temperature of the perishable commodities. For a third example, a quality sensor may comprise an optical sensor for detecting changes in the outlook of the perishable commodities. For a fourth example, a quality sensor may comprise a mechanical sensor for detecting mechanical properties of the perishable commodities. The mechanical property being detected can be for example elasticity of products made of flexible material, e.g. seals made of rubber which lose their quality when rubber hardens due to ageing and/or ambient conditions. For a fifth example, a quality sensor may comprise an electric sensor for detecting electric properties of perishable commodities. The electric property being detected can be for example voltage of batteries, e.g. car batteries, which are for sale and in which a voltage drop is indicative of deterioration in the quality. For a sixth example, a quality sensor may comprise a clock for measuring ageing of perishable commodities, e.g. lubricant oil, whose quality is mainly determined by ageing. For a sixth example, a quality sensor may comprise a humidity sensor for measuring humidity of perishable commodities and/or ambient humidity in the vicinity of the perishable commodities. For example, in conjunction with dry food an increase in the humidity means that the quality is weakening or at least begins to weaken. It is also possible that a quality sensor is a combination of two or more sensors of the kind mentioned above.

In systems according to some exemplifying and non-limiting embodiments of the invention, the one or more quality sensors are arranged to measure the quality-related information continuously. In systems according to other exemplifying and non-limiting embodiments of the invention, the quality sensors are used for carrying out spot checks directed to the perishable commodities. The spot checks can be carried out manually using one or more quality sensors or, in some cases, the spot checks can be automatized.

The system comprises a sale monitoring system 104 for producing sale monitoring data indicative of the consumer demand of the perishable commodities on the basis of the temporal trend of the sale of the perishable commodities. The sale monitoring system 104 can be for example a part of a point of sale “POS” system of a shop. The system comprises a processing and data transfer system 105 for producing quality indicator data on the basis of the information obtained with the quality sensors. The processing and data transfer system 105 is further configured to determine one or more selling prices of the perishable commodities in accordance with at least the quality indicator data and the sale monitoring data provided by the sale monitoring system 104. The selling price related to a given portion of the perishable commodities is determined so that a weakening in the quality of the portion of the perishable commodities tends to decrease the selling price whereas an increase in the consumer demand of the perishable commodities tends to increase the selling price.

In a system according to an exemplifying and non-limiting embodiment of the invention, the processing and data transfer system 105 is configured to send price data indicative of the selling prices to communication terminals of consumers in response to a change in the selling prices. In FIG. 1, one of the communication terminals of consumers is denoted with a reference 106. The communication terminal 106 can be for example a mobile phone, a laptop computer, or a palmtop computer. The selling prices are transmitted to the communication terminals of consumers via a data transfer network 107 that can be a public data and/or telecommunication network. The Internet of Things “IoT” technology can be utilized in the communication between the processing and data transfer system 105 and the communication terminals of consumers. In addition to the above-mentioned price data, quantity data indicative of sellable amounts of the perishable commodities can be sent to the communication terminals of the consumers.

A system according to an exemplifying and non-limiting embodiment of the invention comprises one or more ambient sensors for producing ambient data indicative of one or more ambient conditions of the perishable commodities. In this exemplifying case, the processing and data transfer system 105 is configured to determine the selling prices in accordance with the ambient data too. In FIG. 1, the ambient sensor is denoted with a reference 108. The ambient sensor 108 may comprise for example a temperature sensor, a humidity sensor for measuring air humidity, and/or an optical sensor for measuring illuminance conditions.

In a system according to an exemplifying and non-limiting embodiment of the invention, the processing and data transfer system 105 is configured to determine the selling prices also in accordance with the current weather, a weather forecast, the current time of day, the current day of week, the current month, and/or other data indicative of one or more factors which may have an influence on the buying behavior of consumers.

A system according to an exemplifying and non-limiting embodiment of the invention comprises one or more electronic price labels 109 which are communicatively connected to the processing and data transfer system 105 and configured to display the selling prices determined by the processing and data transfer system 105.

In a system according to an exemplifying and non-limiting embodiment of the invention, the sale monitoring system comprises one or more radio frequency identifiers “RFID” each attached directly to a portion of the perishable commodities, e.g. food, or to a package of the portion of the perishable commodities. In FIG. 1, one of the radio frequency identifiers is denoted with a reference 110. The sale monitoring system 104 comprises at least one frequency identifier reader 111 communicatively connected to the processing and data transfer system 105 so as to enable the processing and data transfer system 105 to detect a situation in which the portion of the perishable commodities is removed from the shelf and sold. The storage system, e.g. a shelf system, may comprise one or more RFID-readers communicatively connected to the processing and data transfer system 105 so as to enable the processing and data transfer system 105 to have up-to-date information about the perishable commodities in the storage system.

In a system according to an exemplifying and non-limiting embodiment of the invention, each of the quality sensors is integrated with a radio frequency identifier “RFID” tag attached directly to a portion of the perishable commodities or to a package of the portion of the perishable commodities. In this case, a quality sensor integrated with a RFID-tag is advantageously not separated from the portion of the perishable commodities when the portion of the perishable commodities is sold. A refrigerator 112 or another storage room at the home of a consumer can be provided with an appropriate RDIF-reader 113 which can be configured to send, to e.g. a mobile communication device of the consumer, up-to-date data indicative of the quality and/or quantity of the perishable commodity. This enables the consumer to reduce e.g. food waste occurring at home.

The processing and data transfer system 105 comprises typically a data transfer network 114 and one or more server computers for determining the selling prices in accordance with the quality indicator data, the sale monitoring data, and possibly with the ambient data and/or other data indicative of one or more factors which may have an influence on the buying behavior of consumers. The one or more server computers are communicatively connected to the data transfer network 114. The data transfer network 114 may comprise for example but not necessarily:
a Bluetooth® or another radio “RF” protocol gateway,
Bluetooth® or other radio links between the one or more quality sensors and the Bluetooth® or the other radio protocol gateway,
a wireless local area network (WLAN) or another wireless network between the Bluetooth® or the other radio protocol gateway and at least one of the server computers.

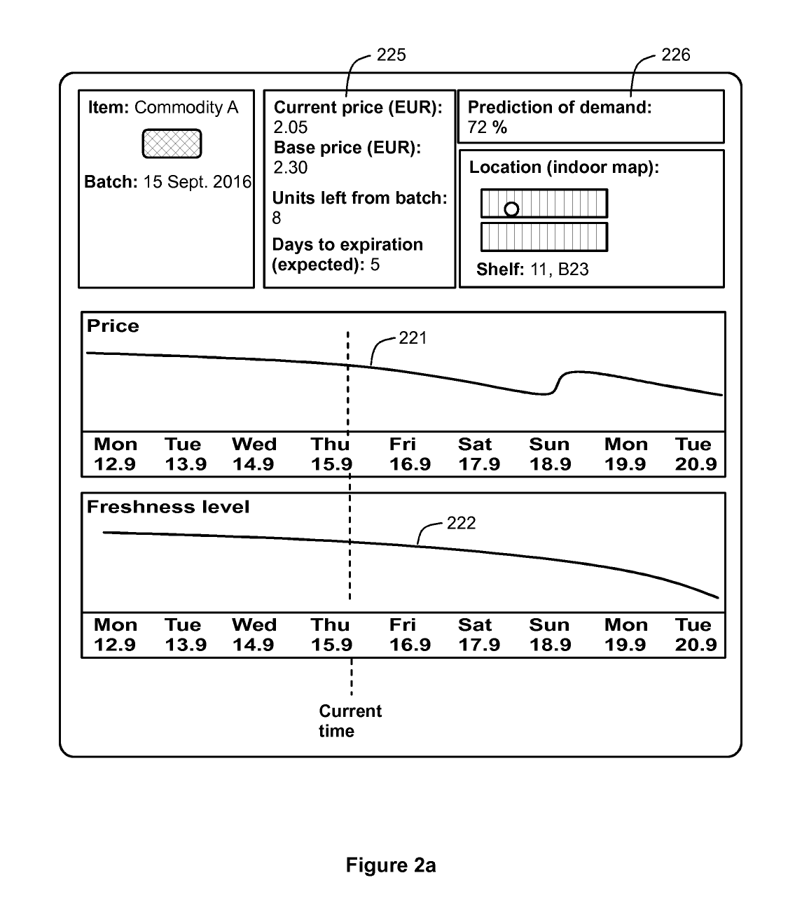

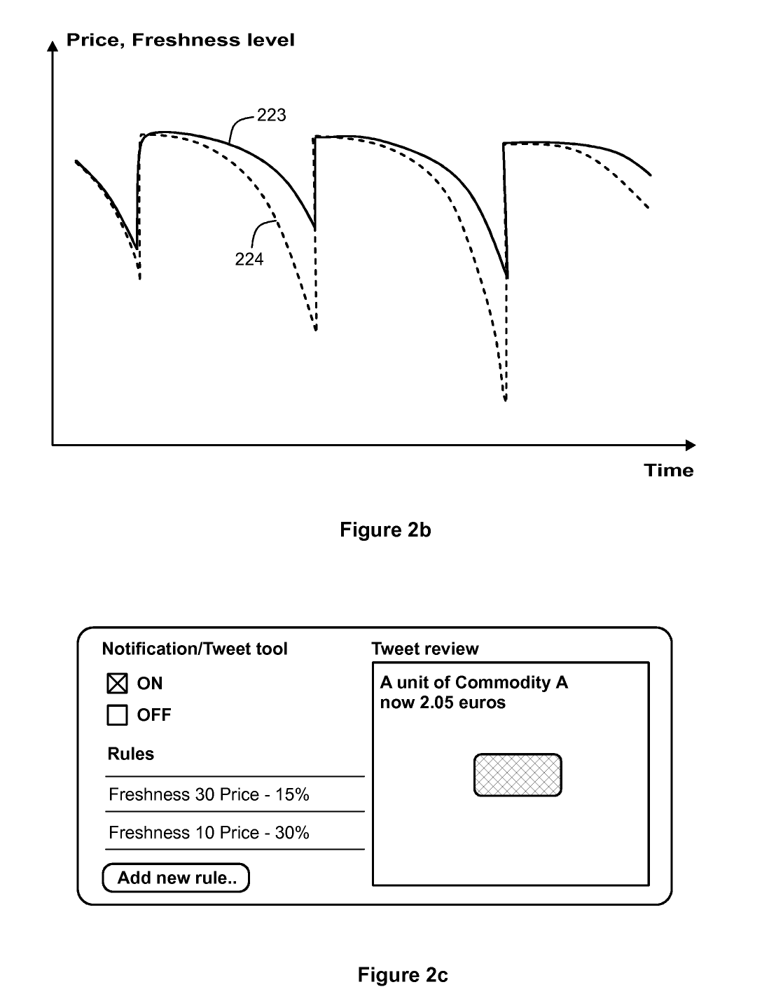

FIG. 2a illustrates operation of a system according to an exemplifying and non-limiting embodiment of the invention for real time marketing of food and/or other perishable commodities. FIG. 2a shows an exemplifying selling price curve 221 and an exemplifying freshness level curve 222 for a portion of Commodity A belonging to a given batch. Commodity A can be for example food. FIG. 2a can show for example an extract of an exemplifying user interface of a system according to an exemplifying and non-limiting embodiment of the invention for real time marketing of food and/or other perishable commodities.

As can be seen from FIG. 2a, there is a temporary increase in the selling price on the Sunday evening 18 September. This temporary increase can be caused by for example the weather forecast, the day of week, and the time of day, i.e. the Sunday evening can be a time when many people are preparing barbeque food if there is a nice weather. The Commodity A can be for example Caesar salad or some other commonly used as accompaniment of barbeque food. The above-mentioned factors may have caused a temporary increase in the actual and/or predicted consumer demand which is, in turn, reflected to the selling price.

A data window 225 shows that there are 8 units of Commodity A left from the batch and approximately 5 days left when these 8 units of Commodity A are fit for use. According to the freshness level curve 222, the current freshness is about 70 . . . 80 on the scale from 0 to 100. A data window 226 shows that the current prediction of the consumer demand is about 72 on the scale from 0 to 100. In this case, the selling price is 2.05 euros which is 0.25 euros less than the 2.30 euros base price.

FIG. 2b shows an exemplifying selling price 223 and an exemplifying freshness level 224 for portions of Commodity A in stock. In FIG. 2b, the selling price 223 as a function of time is presented with a solid line and the freshness level 224 as a function of time is presented with a dashed line. The abrupt changes upwards in the selling price 223 and in the freshness level 224 correspond to time instants when portions of Commodity A are replaced with corresponding new portions of Commodity A.

FIG. 2c shows an extract of an exemplifying user interface of a system according to an exemplifying and non-limiting embodiment of the invention for real time marketing of food and/or other perishable commodities. The “Notification/Tweet tool” “ON” in FIG. 2c means that the selling price, i.e. an offer, is sent to one or more communication terminals of one or more consumers in response to a change in the selling price. The Offer shown in the “Tweet review” in FIG. 2c is: “A unit of Commodity A now 2.05 euros”

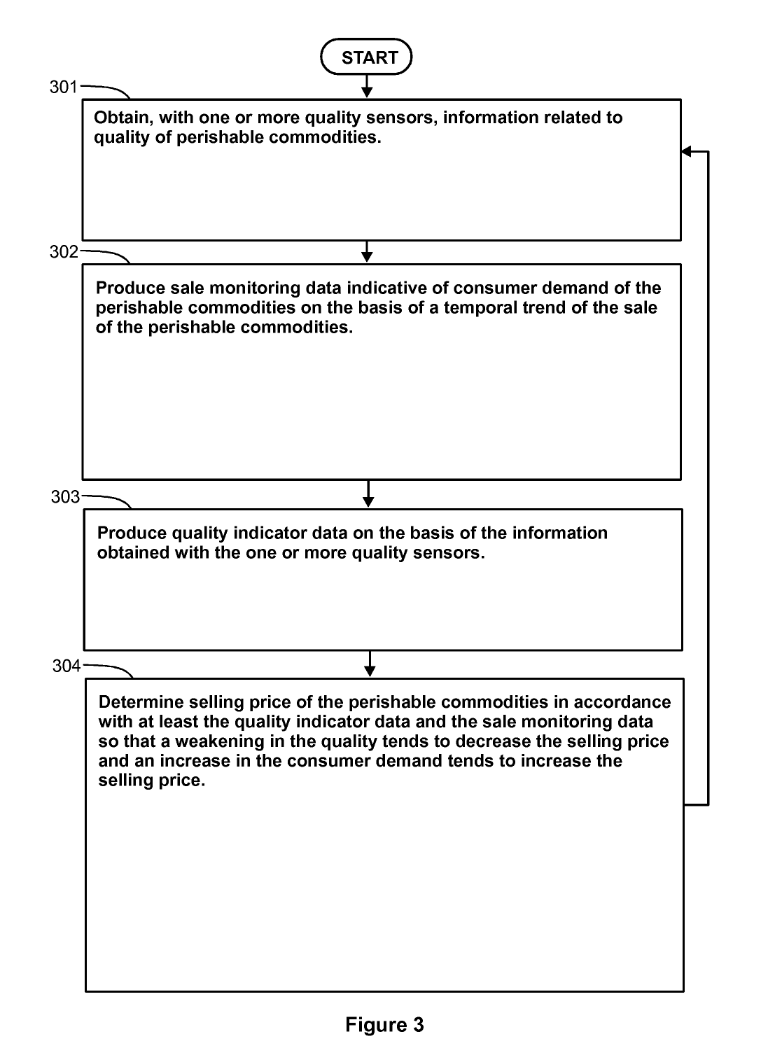

FIG. 3 shows a flowchart of a method according to an exemplifying and non-limiting embodiment of the invention for real time marketing of food and/or other perishable commodities. The method comprises the following actions:
action 301: obtaining, with one or more quality sensors, information related to the quality of the food and/or other perishable commodities,
action 302: producing sale monitoring data indicative of consumer demand of the food and/or other perishable commodities on the basis of the temporal trend of the sale of the food and/or other perishable commodities,
action 303: producing quality indicator data on the basis of the information obtained with the one or more quality sensors, and
action 304: determining one or more selling prices of the food and/or other perishable commodities in accordance with at least the quality indicator data and the sale monitoring data so that a weakening in the quality of a portion of the food and/or other perishable commodities tends to decrease the selling price of this portion of the food and/or other perishable commodities and an increase in the consumer demand of the portion of the food and/or other perishable commodities tends to increase the selling price of the portion of the food and/or other perishable commodities.

A method according to an exemplifying and non-limiting embodiment of the invention comprises sending price data indicative of the selling prices to one or more communication terminals of one or more consumers in response to a change in the selling prices.

A method according to an exemplifying and non-limiting embodiment of the invention comprises sending, together with the price data, quantity data indicative of sellable amounts of the food and/or other perishable commodities to the one or more communication terminals of the one or more consumers.

In a method according to an exemplifying and non-limiting embodiment of the invention, at least one of the quality sensors is a gas sensor for detecting one or more gases in the vicinity of the food and/or other perishable commodities.

In a method according to an exemplifying and non-limiting embodiment of the invention, at least one of the quality sensors is a temperature sensor for detecting temperature of the food and/or other perishable commodities.

In a method according to an exemplifying and non-limiting embodiment of the invention, at least one of the quality sensors is an optical sensor for detecting changes in the outlook of the food and/or other perishable commodities.

In a method according to an exemplifying and non-limiting embodiment of the invention, at least one of the quality sensors is an electric sensor for detecting at least one electric property of the food and/or other perishable commodities.

In a method according to an exemplifying and non-limiting embodiment of the invention, at least one of the quality sensors is a mechanical sensor for detecting at least one mechanical property of the food and/or other perishable commodities.

A method according to an exemplifying and non-limiting embodiment of the invention comprises producing ambient data indicative of one or more ambient conditions of the food and/or other perishable commodities, and determining the selling prices in accordance with the ambient data too.

In a method according to an exemplifying and non-limiting embodiment of the invention, the producing the ambient data comprises detecting the ambient temperature from at least one room containing the food and/or other perishable commodities.

In a method according to an exemplifying and non-limiting embodiment of the invention, the producing the ambient data comprises measuring the air humidity from at least one room containing the food and/or other perishable commodities.

In a method according to an exemplifying and non-limiting embodiment of the invention, the producing the ambient data comprises measuring illuminance conditions from at least one room containing the food and/or other perishable commodities.

A method according to an exemplifying and non-limiting embodiment of the invention comprises determining the selling prices in accordance also with the current weather, a weather forecast, the current time of day, the current day of week, the current month, and/or other data indicative of one or more factors which may have an influence on the buying behavior of consumers.

A method according to an exemplifying and non-limiting embodiment of the invention comprises displaying the one or more selling prices with one or more electronic price labels located in the vicinity of the food and/or other perishable commodities.

In a method according to an exemplifying and non-limiting embodiment of the invention, the producing the sale monitoring data comprises detecting a situation in which a portion of the food and/or other perishable commodities is removed from a shelf and sold. The above-mentioned situation is detected by reading a radio frequency identifier “RFID” tag attached directly to the portion of the food and/or other perishable commodities or to a package of the portion of the food and/or other perishable commodities.

In a method according to an exemplifying and non-limiting embodiment of the invention, the producing the quality indicator data is preceded by reading one or more radio frequency identifiers “RFID” each integrated with a quality sensor and attached directly to a portion of the food and/or other perishable commodities or to a package of the portion of the food and/or other perishable commodities.

A computer program according to an exemplifying and non-limiting embodiment of the invention comprises computer executable instructions for controlling a programmable processing system to carry out actions related to a method according to any of the above-described exemplifying embodiments of the invention.

A computer program according to an exemplifying and non-limiting embodiment of the invention comprises software modules for the purpose of real time marketing of food and/or other perishable commodities. The software modules comprise computer executable instructions for controlling a programmable processing system to:
produce sale monitoring data indicative of the consumer demand of the food and/or other perishable commodities on the basis of the temporal trend of the sale of the food and/or other perishable commodities,
produce quality indicator data indicative of the quality of the food and/or other perishable commodities on the basis of information obtained with one or more quality sensors and related to the quality of the food and/or other perishable commodities, and
determine one or more selling prices of the food and/or other perishable commodities in accordance with at least the quality indicator data and the sale monitoring data, a weakening in the quality of a portion of the food and/or other perishable commodities tending to decrease the selling price of this portion of the food and/or other perishable commodities and an increase in the consumer demand of the portion of the food and/or other perishable commodities tending to increase the selling price of the portion of the food and/or other perishable commodities.

The above-mentioned software modules can be e.g. subroutines or functions implemented with a suitable programming language and with a compiler suitable for the programming language and the programmable processing system under consideration. It is worth noting that also a source code corresponding to a suitable programming language represents the computer executable software modules because the source code contains the information needed for controlling the programmable processing system to carry out the above-presented actions and compiling changes only the format of the information. Furthermore, it is also possible that the programmable processing system is provided with an interpreter so that a source code implemented with a suitable programming language does not need to be compiled prior to running.

A computer program product according to an exemplifying and non-limiting embodiment of the invention comprises a computer readable medium, e.g. a compact disc “CD”, encoded with a computer program according to an exemplifying embodiment of invention.

A signal according to an exemplifying and non-limiting embodiment of the invention is encoded to carry information defining a computer program according to an exemplifying embodiment of invention.

The specific examples provided in the description given above should not be construed as limiting the scope and/or the applicability of the accompanied claims. Lists and groups of examples provided in the description given above are not exhaustive unless otherwise explicitly stated.

1. A system for marketing perishable commodities, the system comprising:
one or more quality sensors for obtaining information related to quality of the perishable commodities,
a sale monitoring system for producing sale monitoring data indicative of consumer demand of the perishable commodities on the basis of a temporal trend of sale of the perishable commodities, and
a processing and data transfer system for producing quality indicator data on the basis of the information obtained with the one or more quality sensors,
wherein the processing and data transfer system is configured to determine one or more selling prices of the perishable commodities in accordance with at least the quality indicator data and the sale monitoring data, a weakening in the quality of a portion of the perishable commodities tending to decrease the selling price of this portion of the perishable commodities and an increase in the consumer demand of the portion of the perishable commodities tending to increase the selling price of the portion of the perishable commodities.

2. A system according to claim 1, wherein the processing and data transfer system is configured to send price data indicative of the selling prices to one or more communication terminals of one or more consumers in response to a change in the selling prices.

3. A system according to claim 2, wherein the processing and data transfer system is configured to send, together with the price data, quantity data indicative of sellable amounts of the perishable commodities to the one or more communication terminals of the one or more consumers.

4. A system according to claim 1, wherein at least one of the quality sensors is a gas sensor for detecting one or more gases in the vicinity of the perishable commodities.

5. A system according to claim 1, wherein at least one of the quality sensors is a temperature sensor for detecting temperature of the perishable commodities.

6. A system according to claim 1, wherein at least one of the quality sensors is an optical sensor for detecting changes in outlook of the perishable commodities.

7. A system according to claim 1, wherein the system comprises one or more ambient sensors for producing ambient data indicative of one or more ambient conditions of the perishable commodities, and the processing and data transfer system is configured to determine the selling prices in accordance with the ambient data.

8. A system according to claim 7, wherein at least one of the ambient sensors is a temperature sensor.

9. A system according to claim 7, wherein at least one of the ambient sensors is a humidity sensor for measuring air humidity.

10. A system according to claim 7, wherein at least one of the ambient sensors is an optical sensor for measuring illuminance conditions.

11. A system according to claim 1, wherein the processing and data transfer system is configured to determine the selling prices in accordance with at least one of the following: current weather, a weather forecast, a current time of day, a current day of week, a current month.

12. A system according to claim 1, wherein the system comprises one or more electronic price labels connected to the processing and data transfer system and configured to display the selling prices determined by the processing and data transfer system.

13. A system according to claim 1, wherein the sale monitoring system comprises one or more radio frequency identifiers each attached directly to a portion of the perishable commodities or to a package of the portion of the perishable commodities, and the sale monitoring system comprises one or more radio frequency identifier readers communicatively connected to the processing and data transfer system so as to enable the processing and data transfer system to detect a situation in which the portion of the perishable commodities is removed from a shelf and sold.

14. A system according to claim 1, wherein each of the quality sensors is integrated with a radio frequency identifier attached directly to a portion of the perishable commodities or to a package of the portion of the perishable commodities.

15. A system according to claim 1, wherein the processing and data transfer system comprises a data transfer network and one or more server computers for determining the selling prices in accordance with at least the quality indicator data and the sale monitoring data, the one or more server computers being communicatively connected to the data transfer network.

16. A system according to claim 15, wherein the data transfer network comprises:
a radio protocol gateway,
radio links between the one or more quality sensors and the radio protocol gateway,
a wireless network between the radio protocol gateway and at least one of the server computers.

17. A method for marketing perishable commodities, the method comprising:
obtaining, with one or more quality sensors, information related to quality of the perishable commodities,
producing sale monitoring data indicative of consumer demand of the perishable commodities on the basis of a temporal trend of sale of the perishable commodities, and
producing quality indicator data on the basis of the information obtained with the one or more quality sensors,
wherein the method further comprises determining one or more selling prices of the perishable commodities in accordance with at least the quality indicator data and the sale monitoring data, a weakening in the quality of a portion of the perishable commodities tending to decrease the selling price of this portion of the perishable commodities and an increase in the consumer demand of the portion of the perishable commodities tending to increase the selling price of the portion of the perishable commodities.

18. A method according to claim 17, wherein the method comprises sending price data indicative of the selling prices to one or more communication terminals of one or more consumers in response to a change in the selling prices.

19. A method according to claim 18, wherein the method comprises sending, together with the price data, quantity data indicative of sellable amounts of the perishable commodities to the one or more communication terminals of the one or more consumers.

20. A method according to claim 17, wherein at least one of the quality sensors is a gas sensor for detecting one or more gases in the vicinity of the perishable commodities.

21. A method according to claim 17, wherein at least one of the quality sensors is a temperature sensor for detecting temperature of the perishable commodities.

22. A method according to claim 17, wherein at least one of the quality sensors is an optical sensor for detecting changes in outlook of the perishable commodities.

23. A method according to claim 17, wherein the method comprises producing ambient data indicative of one or more ambient conditions of the perishable commodities, and determining the selling prices in accordance with the ambient data.

24. A method according to claim 23, wherein the producing the ambient data comprises detecting ambient temperature from at least one room containing the perishable commodities.

25. A method according to claim 23, wherein the producing the ambient data comprises measuring air humidity from at least one room containing the perishable commodities.

26. A method according to claim 23, wherein the producing the ambient data comprises measuring illuminance conditions from at least one room containing the perishable commodities.

27. A method according to claim 17, wherein the method comprises determining the selling prices in accordance with at least one of the following: current weather, a weather forecast, a current time of day, a current day of week, a current month.

28. A method according to claim 17, wherein the method comprises displaying the one or more selling prices with one or more electronic price labels located in the vicinity of the perishable commodities.

29. A method according to claim 17, wherein the producing the sale monitoring data comprises detecting a situation, in which a portion of the perishable commodities is removed from a shelf and sold, by reading a radio frequency identifier (RFID) attached directly to the portion of the perishable commodities or to a package of the portion of the perishable commodities.

30. A method according to claim 17, wherein the producing the quality indicator data is preceded by reading one or more radio frequency identifiers (RFID) each integrated with one of the quality sensors and attached directly to a portion of the perishable commodities or to a package of the portion of the perishable commodities.

31. A method according to claim 17, wherein the perishable commodities comprise food.

32. A computer program for marketing perishable commodities, the computer program comprising computer executable instructions for controlling a programmable processing system to:
produce sale monitoring data indicative of consumer demand of the perishable commodities on the basis of a temporal trend of sale of the perishable commodities,
produce quality indicator data indicative of quality of the perishable commodities on the basis of information obtained with one or more quality sensors and related to the quality of the perishable commodities, and
determine one or more selling prices of the perishable commodities in accordance with at least the quality indicator data and the sale monitoring data, a weakening in the quality of a portion of the perishable commodities tending to decrease the selling price of this portion of the perishable commodities and an increase in the consumer demand of the portion of the perishable commodities tending to increase the selling price of the portion of the perishable commodities.

33. A computer program product comprising a non-transitory computer readable medium encoded with a computer program according to claim 32.
